(19) United States
(12) Patent Application Publication
(10) Pub. No.: US 2025/0046834 A1
(43) Pub. Date: Feb. 6, 2025

(54) AIR-COOLED FUEL CELL SYSTEM

(71) Applicant: TOYOTA JIDOSHA KABUSHIKI KAISHA, Toyota-shi (JP)

(72) Inventors: Takahiro UMEHARA, Susono-shi (JP); Nobuaki NONOYAMA, Chiryu-shi (JP)

(73) Assignee: TOYOTA JIDOSHA KABUSHIKI KAISHA, Toyota-shi (JP)

(21) Appl. No.: 18/787,125

(22) Filed: Jul. 29, 2024

(30) Foreign Application Priority Data
Jul. 31, 2023 (JP) 2023-124079

(51) Int. Cl. H01M 8/04014; H01M 8/0258; H01M 8/0267; H01M 8/04082; H01M 8/04089; H01M 8/04537; H01M 8/04746; H01M 8/04858

(52) U.S. Cl. CPC H01M 8/04014; H01M 8/0258; H01M 8/0267; H01M 8/04089; H01M 8/04201; H01M 8/04552; H01M 8/04753; H01M 8/04768; H01M 8/04925

(57) ABSTRACT

To provide a fuel cell system capable of appropriately recovering the activity of a cathode catalyst is provided. An air-cooled fuel cell system, wherein the fuel cell system comprises a fuel cell, a hydrogen system for supplying hydrogen to the fuel cell, a reaction air system for supplying reaction air to the fuel cell, and a cooling air system for supplying cooling air to the fuel cell; wherein the fuel cell comprises a reaction air flow path and a cooling air flow path and has a flow path structure in which the reaction air and the cooling air are independent.

### CROSS-REFERENCE

This application claims priority to Japanese Patent Application No. 2023-124079 filed on Jul. 31, 2023, incorporated herein by reference in its entirety.

### TECHNICAL FIELD

The present disclosure relates to an air-cooled fuel cell system.

### BACKGROUND

Various studies have been proposed for fuel cells (FC) as disclosed in Patent Documents 1 to 5.
Patent Document 1: Japanese Patent Application Laid-Open (JP-A) No. 2005-216783
Patent Document 2: JP-A No. 2017-510954
Patent Document 3: JP-A No. 2022-185251
Patent Document 4: JP-A No. 2022-185247
Patent Document 5: JP-A No. 2008-192468

In the conventional open air-cooled fuel cell, the inflow of cooling air and reaction air cannot be restricted at the same time. Accordingly, when the activity of the cathode catalyst of the fuel cell decreases, recovery control for increasing the activity cannot be carried out.

### SUMMARY

The disclosure was achieved in light of the above circumstances. An object of the disclosure is to provide an air-cooled fuel cell system capable of appropriately recovering the activity of a cathode catalyst.

In the first embodiment of the present disclosure, there is provided an air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent; and
wherein, when an activity of a cathode catalyst of the fuel cell is reduced and a recovery control for increasing the activity is required, as the recovery control, the fuel cell system is configured to reduce the amount of the reaction air supplied to the fuel cell, while keeping the supply of the hydrogen to the fuel cell and the supply of the cooling air to the fuel cell.

According to the second embodiment of the present disclosure, in the first embodiment, wherein the reaction air system may comprise a reaction air blowing device;

wherein the cooling air system may comprise a cooling air blowing device;

wherein a hydrogen discharge flow path of the hydrogen system may merge with a cooling air discharge flow path of the cooling air system; and
wherein, during the recovery control, the fuel cell system may be configured to stop the reaction air blowing device and drive the cooling air blowing device to dilute the hydrogen with the cooling air and discharge the diluted hydrogen to the outside of the fuel cell system.

According to the third embodiment of the present disclosure, in the first embodiment, the fuel cell system may be configured to increase the amount of the reaction air supplied to the fuel cell, when at least one of the following is satisfied: a condition that a voltage of the fuel cell decreases to a predetermined voltage after the start of the recovery control, and a condition that a predetermined time elapses after the start of the recovery control.

According to the fourth embodiment of the present disclosure, in the first embodiment,
the fuel cell system may comprise an electrical system;
wherein the electrical system may comprise a diode on a power line with the fuel cell; and
wherein the fuel cell system may be configured to connect the fuel cell to the power line during the recovery control.

According to the fifth embodiment of the present disclosure, in the first embodiment,
the fuel cell system may comprise an electrical system;
wherein the electrical system may comprise a relay for the fuel cell on a power line with the fuel cell; and
wherein the fuel cell system may be configured to turn off the relay for the fuel cell during the recovery control.

The present disclosure can appropriately recover the activity of the cathode catalyst.

### BRIEF DESCRIPTION OF THE DRAWINGS

In the accompanying drawings,

FIG. 1 is a schematic exploded perspective view showing an example of a unit cell of the fuel cell included in the fuel cell system of the present disclosure;

FIG. 2 is a schematic perspective view showing an example of a fuel cell stack included in the fuel cell system of the present disclosure;

FIG. 3 is a system configuration diagram showing an example of the fuel cell system of the present disclosure;

FIG. 4 is a circuit diagram showing an example of the electrical system included in the fuel cell system of the present disclosure;

FIG. 5 is a flowchart showing an example of the control of the fuel cell system of the present disclosure; and

FIG. 6 is a flowchart showing another example of the control of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidizing gas is a gas containing oxygen, and may be oxygen, air, or the like. In the present disclosure, air as an oxidant gas is referred to as reaction air, and air as a cooling gas is referred to as cooling air.

In the present disclosure, there is provided an air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent; and
wherein, when an activity of a cathode catalyst of the fuel cell is reduced and a recovery control for increasing the activity is required, as the recovery control, the fuel cell system is configured to reduce the amount of the reaction air supplied to the fuel cell, while keeping the supply of the hydrogen to the fuel cell and the supply of the cooling air to the fuel cell.

The present disclosure relates to performance improvement of an air-cooled fuel cell, and in a system in which a reaction air and a cooling air are provided with independent flow paths, a refresh effect of a cathode catalyst is obtained by controlling a reaction air system and reducing a voltage.

In an air-cooled fuel cell, a volume of a fluid used for cooling is larger than in a water-cooled fuel cell, and a flow path structure for flowing a fluid is also larger.

For example, the cooling water required to cool 4 kW needs to be 5 L/min or more than 10,000 L/min.

When the power generation operation of the fuel cell is continued, the catalytic activity decreases due to the accumulation of the oxide on the catalyst surface of the cathode, and the power generation efficiency decreases. At this time, the power generation efficiency can be recovered by performing the refresh process. For the refresh process, it is necessary to lower the cell potential by bringing the cathode into an oxygen-deficient state. Further, since the power supply during refresh is reduced, it is necessary to perform the refresh in as short a time as possible.

In an open air-cooled fuel cell, since the reaction air system cannot be sealed, the potential cannot be lowered in a non-power generation state, or if the sealed space is large, it takes a long time to lower the potential. In addition, in the case of lowering the potential while generating electricity, complicated control such as balancing the current and the air flow rate is required.

In an open air-cooled fuel cell, since there is only one air blowing device, it is not possible to stop the air blowing device due to dilution of exhaust hydrogen, when lowering the potential, it is necessary to perform complicated control while generating electricity, or to provide an auxiliary device such as a bypass valve.

Therefore, in an open air-cooled fuel cell, it is structurally difficult to seal the air system, and even if the air system can be sealed, the sealing volume is considerably large, and it is difficult to perform the refresh process by lowering the potential in a short time.

The fuel cell system includes a fuel cell in which hydrogen and air react to generate power, a hydrogen system in which hydrogen necessary for power generation of the fuel cell is supplied to the fuel cell, a reaction air system in which reaction air is supplied to the fuel cell, and a cooling air system in which cooling air for cooling heat generated by power generation is supplied to the fuel cell.

The fuel cell may have only one unit cell of the fuel cell, or may be a fuel cell stack which is a stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The fuel cell stack may have corrugated cooling fins that serve as the cooling air flow path in each unit cell.

The fuel cell stack may include a current collector plate, a pressure plate, and the like at an end portion in the stacking direction.

The unit cell of the fuel cell may have a reaction air flow path (oxidant gas flow path) and a cooling air flow path (cooling gas flow path) having a flow path structure in which the reaction air and the cooling air are independent, and may further have a hydrogen gas flow path (fuel gas flow path).

The flow path structure in which the reaction air and the cooling air are independent means that there is no sharing of air between the flow paths from the supply of air to the fuel cell to the discharge of air from the fuel cell. The flow path for discharging the air discharged from the fuel cell to the outside of the fuel cell system may be independent or may not be independent.

The unit cell may have a flow path structure for flowing the reaction air and the cooling air so that the flow of the cooling air and the flow of the reaction air intersect each other in a plan view. The flow of cooling air and the flow of reaction air may intersect or be orthogonal.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are an anode (fuel electrode or hydrogen electrode) and a cathode (oxygen electrode or air electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell of the fuel cell may include a separator.

The separator collects current generated by power generation and functions as a partition wall. In a unit cell of a fuel cell, the separator is usually disposed on both sides of the power generation unit in the stacking direction so that a pair of separators sandwich the power generation unit. One of the pair of separators is an anode separator and the other is a cathode separator.

The anode separator may have a groove that serves as a hydrogen gas flow path on a surface on the side of the power generation unit, and may have a groove that serves as a cooling air flow path on a surface on the side opposite to the power generation unit.

The cathode separator may have a groove that serves as a reaction air flow path on a surface on the side of the power generation unit, and may have a groove that serves as a cooling air flow path on a surface on the side opposite to the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer.

The fuel cell system may include a control device. The control device may control the entire fuel cell system by controlling the reaction air system, the hydrogen system, the cooling air system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be a ECU (electronic control unit).

The reaction air system supplies reaction air as an oxidant gas to the fuel cell and regulates a flow rate of the reaction air. The reaction air system may include a reaction air pipe or the like.

The hydrogen system supplies hydrogen as a fuel gas to the fuel cell and adjusts the flow rate of the hydrogen. The hydrogen system may include a hydrogen tank, a hydrogen inlet valve, an injector, a gas-liquid separator, a hydrogen purge valve, an ejector for hydrogen circulation, a hydrogen pump for hydrogen circulation, and a hydrogen pipe.

The cooling air system supplies cooling air as a cooling gas to the fuel cell and adjusts a flow rate of the cooling air.

The reaction air system may include an inlet-side sealing valve at an inlet of the reaction air of the fuel cell and an outlet-side sealing valve at an outlet of the reaction air of the fuel cell.

In the present disclosure, the fuel cell has a flow path structure in which the reaction air and the cooling air are independent from each other, and in the reaction air system, a valve (an inlet-side sealing valve and an outlet-side sealing valve) is installed at the inlet and outlet of the reaction air of the fuel cell, so that the fuel cell can seal the cathode of the fuel cell with a smaller volume as compared with a case where the reaction air and the cooling air have a common flow path structure. When the activity of the cathode catalyst of the fuel cell decreases during power generation of the fuel cell and recovery control to increase the activity is required, the potential of the fuel cell can be lowered in a short time by rapidly consuming a small amount of sealed oxygen by sealing the valve at the inlet and outlet of the reaction air.

At this time, since the hydrogen of the anode is consumed, the hydrogen supply is continued in order to suppress the catalyst deterioration caused by the generation of the abnormal potential due to the hydrogen shortage.

When the activity of the cathode catalyst of the fuel cell decreases and recovery control to increase the activity is required, the fuel cell system reduces the supply amount of the reaction air to the fuel cell while maintaining the supply of the hydrogen to the fuel cell and the supply of the cooling air to the fuel cell as the recovery control.

In the recovery control (refresh process), hydrogen is supplied to the fuel cell in order to prevent an abnormal potential. During the recovery control (refresh process), at least the supply amount of the reaction air to the fuel cell is reduced, and if necessary, the supply of the reaction air to the fuel cell is stopped, and the inlet/outlet valves (inlet-side sealing valve and outlet-side sealing valve) of the reaction air system are closed to seal the cathode of the fuel cell. Then, the fuel cell is lowered until a predetermined voltage is reached. When the fuel cell reaches a predetermined voltage, the inlet/outlet valves (inlet-side sealing valve and outlet-side sealing valve) of the reaction air system are opened.

The recovery control may be determined to be necessary when at least one of the following conditions is satisfied. When the voltage of the fuel cell deviates from the assumed voltage, when continuous power generation operation is performed for a certain period of time or longer, and when the fuel cell is left in non-power generation for a certain period of time or longer. That is, when at least one of these conditions is satisfied, it may be considered that the activity of the cathode catalyst has decreased.

In the present disclosure, the fuel cell system may increase the supply amount of the reaction air to the fuel cell when the voltage of the fuel cell drops to a predetermined voltage after the start of the recovery control or at least one of the conditions until the predetermined time elapses is satisfied.

Whether or not to end the recovery control may be determined by any of the following or a combination thereof. A voltage sensor may be installed at both ends of the fuel cell stack to detect the total voltage, and the total voltage value may be determined to be the end of the recovery control by lowering the total voltage value to a predetermined voltage. A voltage sensor may be installed in all or some of the cells, and the voltage value of at least one of the cells may be determined to be the end of the recovery control by lowering the voltage value to a predetermined voltage. It is also possible to record in advance a time until the voltage is reduced to a predetermined voltage, and determine that the recovery control is ended by the lapse of the predetermined time.

The reaction air system may have a reaction air blowing device, the cooling air system may have a cooling air blowing device, and the hydrogen discharge flow path of the hydrogen system may merge with the cooling air discharge flow path of the cooling air system.

The hydrogen-based hydrogen discharge flow path may further include a merging portion that can merge with the reaction air discharge flow path of the reaction air system.

Has independent blowing device in the reaction air system and the cooling air system, and, by the hydrogen discharge flow path merges with the cooling air discharge flow path, at the time of recovery control, the fuel cell system stops the reaction air blowing device, and by driving the cooling air blowing device, it is possible to discharge to the outside of the fuel cell system by diluting the hydrogen with cooling air, and it is possible to perform temperature control.

The reaction air blowing device and the cooling air blowing device may be an air compressor, an air pump, an air blower, an air fan, and the like, respectively.

The reaction air system may have a reaction air inlet for taking the reaction air from the outside of the fuel cell system, and the reaction air inlet may be provided with a pressure loss body such as an air filter.

The cooling air system may have a cooling air inlet for taking cooling air from the outside of the fuel cell system, and a pressure loss body such as an air filter may be provided in the cooling air inlet.

The fuel cell system may comprise an electrical system.

The electrical system may comprise a diode on the power line with the fuel cell and may or may not further comprise a relay for the fuel cell. By having the diode, generation of a reverse current from the power line side to the fuel cell can be avoided.

The fuel cell system may connect the fuel cell to the power line during recovery control.

By performing the recovery control while the fuel cell is connected to the power line, the oxygen consumption of the reaction air system ends quickly, and the time of the recovery control is shortened. Further, when the fuel cell is disconnected from the power line during the recovery control and the fuel cell is brought into the open circuit state, when hydrogen is present at the cathode and the anode, the cell voltage rises to a high potential (near 1.0V), the oxidation of the catalyst proceeds, and the performance degradation of the catalyst layer progresses. However, by performing the recovery control while the fuel cell is connected to the power line, the voltage of the fuel cell is suppressed to the fuel cell voltage V1≤the power line voltage V2, so that it is possible to avoid the cell becoming a high potential during the recovery control.

The electric system may have a relay for a fuel cell on a power line with the fuel cell, and may or may not have a diode.

The fuel cell system may turn off the fuel cell relay during recovery control when the electrical system has a fuel cell relay on the power line and does not have a diode.

When the diode is not installed on the electric power line of the electric system due to the cost and physique of the fuel cell system, the cell is temporarily brought to a high potential, but recovery control may be performed after the relay is disconnected in order to prevent reverse current from the electric power line.

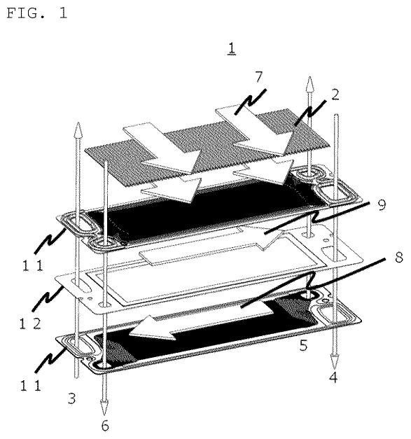

FIG. 1 is a schematic exploded perspective view showing an example of a unit cell of the fuel cell included in the fuel cell system of the present disclosure.

The unit cell 1 shown in FIG. 1 includes a cooling fin (cooling air flow path) 2 serving as a flow path for cooling air (cooling gas) 7, a reaction air inlet 3, a reaction air outlet 4, a hydrogen gas inlet 5, a hydrogen gas outlet 6, two separators 11, a MEA sandwiched between the two separators 11, and a resin frame 12. As shown in FIG. 1, the unit cell 1 of the fuel cell has a flow path structure in which the reaction air 9 and the cooling air 7 are independent from each other.

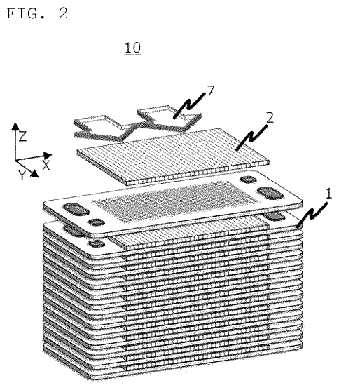

FIG. 2 is a schematic perspective view showing an example of a fuel cell stack included in the fuel cell system of the present disclosure.

The fuel cell stack 10 shown in FIG. 2 is a stacked body in which a plurality of unit cells 1 are stacked.

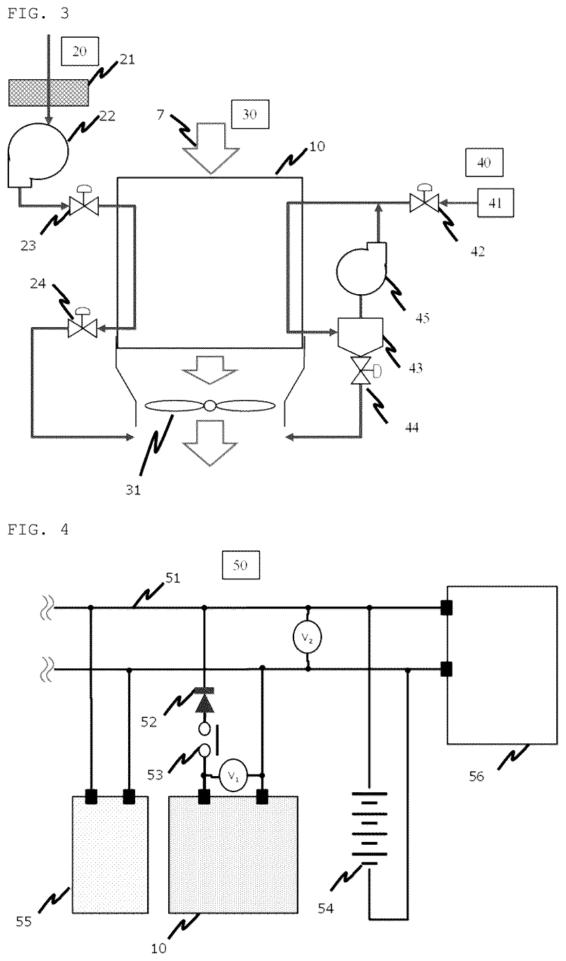

FIG. 3 is a system configuration diagram showing an example of the fuel cell system of the present disclosure.

The fuel cell system shown in FIG. 3 includes a fuel cell stack 10, a reaction air system 20, a cooling air system 30, and a hydrogen system 40. The reaction air system 20 includes a reaction air intake port 21, an air blower 22, an inlet-side sealing valve 23, and an outlet-side sealing valve 24. The cooling air system 30 includes a cooling fan 31. The hydrogen system 40 includes a hydrogen tank 41, a hydrogen inlet valve 42, a gas-liquid separator 43, a hydrogen purge valve 44, and a hydrogen pump 45. The fuel cell system shown in FIG. 3 includes sealing valves 23 and 24 at the entrance and exit of the reaction air system 20, and independent blowing device 22 and 31 for the reaction air system 20 and the cooling air system 30.

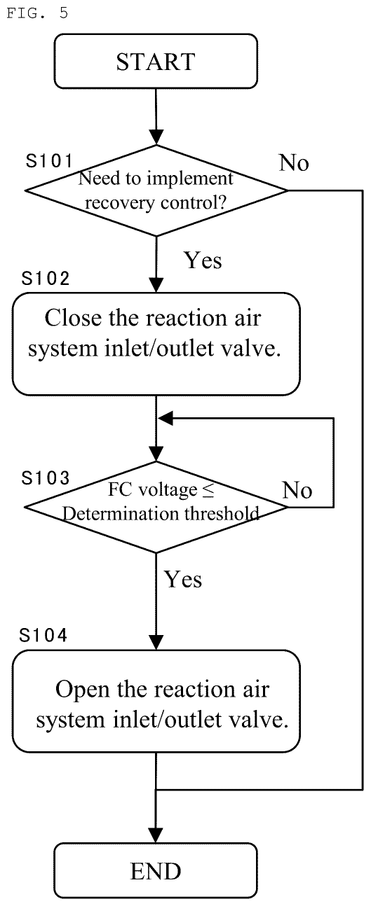

FIG. 4 is a circuit diagram showing an example of the electrical system included in the fuel cell system of the present disclosure.

The electrical system 50 shown in FIG. 4 includes a power line 51, a diode 52, a relay 53, power consumption absorbing device 54 such as a battery/capacitor, auxiliary equipment 55, and power consumption equipment 56.

By installing the diode 52 on the power line 51, the fuel cell stack 10 is connected to the power line 51 at the time of recovery control, so that it is possible to shorten the time of recovery control while avoiding the generation of a reverse current from the power line 51 side to the fuel cell stack 10.

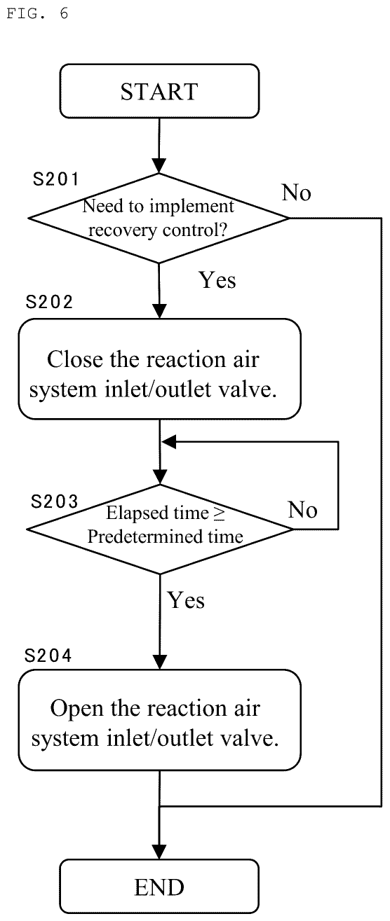

FIG. 5 is a flowchart showing an example of the control of the fuel cell system of the present disclosure.

First, the fuel cell system determines whether or not recovery control is necessary (S101). When it is determined that the recovery control is necessary, the fuel cell system closes the inlet/outlet valve of the reaction air system and starts the recovery control (S102). Then, the fuel cell system determines whether or not the voltage of the fuel cell has decreased to a predetermined determination threshold (S103).

When it is determined that the voltage of the fuel cell has decreased to a predetermined determination threshold, the fuel cell system opens the inlet/outlet valve of the reaction air system (S104), and ends the recovery control.

FIG. 6 is a flowchart showing another example of the control of the fuel cell system of the present disclosure.

First, the fuel cell system determines whether or not recovery control is necessary (S201). When it is determined that the recovery control is necessary, the fuel cell system closes the inlet/outlet valve of the reaction air system and starts the recovery control (S202). Then, the fuel cell system determines whether or not the execution time of the recovery control has elapsed for a predetermined time (S203). When it is determined that the execution time of the recovery control has elapsed for a predetermined period of time, the fuel cell system opens the inlet/outlet valve of the reaction air system (S204) and ends the recovery control.

### REFERENCE SIGNS LIST

1. Unit cell
2. Cooling fin (cooling air flow path)
3. Reaction air inlet
4. Reaction air outlet
5. Hydrogen gas inlet
6. Hydrogen gas outlet
7. Cooling air (cooling gas)
8. Hydrogen gas
9. Reaction air
10. Fuel cell stack
11. Separator
12. MEA, resin frame
20. Reactive air system
21. Reaction air inlet
22. Air blower
23. Inlet side sealing valve
24. Outlet side sealing valve
30. Cooling air system
31. Cooling fan
40. Hydrogen system
41. Hydrogen tank
42. Hydrogen inlet valve
43. Gas separator
44. Hydrogen purge valve
45. Hydrogen pump
50. Electric system
51. Power line
52. Diode
53. Relay
54. Power consumption absorbing device
55. Auxiliaries
56. Power consuming equipment

1. An air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent; and
wherein, when an activity of a cathode catalyst of the fuel cell is reduced and a recovery control for increasing the activity is required, as the recovery control, the fuel cell system is configured to reduce the amount of the reaction air supplied to the fuel cell, while keeping the supply of the hydrogen to the fuel cell and the supply of the cooling air to the fuel cell.

2. The fuel cell system according to claim 1,
wherein the reaction air system comprises a reaction air blowing device;
wherein the cooling air system comprises a cooling air blowing device;
wherein a hydrogen discharge flow path of the hydrogen system merges with a cooling air discharge flow path of the cooling air system; and
wherein, during the recovery control, the fuel cell system is configured to stop the reaction air blowing device and drive the cooling air blowing device to dilute the hydrogen with the cooling air and discharge the diluted hydrogen to the outside of the fuel cell system.

3. The fuel cell system according to claim 1, wherein the fuel cell system is configured to increase the amount of the reaction air supplied to the fuel cell, when at least one of the following is satisfied: a condition that a voltage of the fuel cell decreases to a predetermined voltage after the start of the recovery control, and a condition that a predetermined time elapses after the start of the recovery control.

4. The fuel cell system according to claim 1,
wherein the fuel cell system comprises an electrical system;
wherein the electrical system comprises a diode on a power line with the fuel cell; and
wherein the fuel cell system is configured to connect the fuel cell to the power line during the recovery control.

5. The fuel cell system according to claim 1,
wherein the fuel cell system comprises an electrical system;
wherein the electrical system comprises a relay for the fuel cell on a power line with the fuel cell; and
wherein the fuel cell system is configured to turn off the relay for the fuel cell during the recovery control.

6. The fuel cell system according to claim 1,
wherein the fuel cell comprises at least one of unit cell,
wherein the unit cell comprises an anode separator, a power generation unit, and a cathode separator, in this order,
wherein the cathode separator comprises the reaction air flow path on the side of the power generation unit, and comprises the cooling air flow path on the side opposite to the power generation unit.

7. The fuel cell system according to claim 6,
wherein the unit cell comprises a corrugated cooling fin as the cooling air flow path.
